(19) United States
(12) Patent Application Publication
(10) Pub. No.: US 2004/0102160 A1
(43) Pub. Date: May 27, 2004

(54) Master slave cellular communication system

(76) Inventors: Dmitri A. Sleptchenko, Roslindale, MA (US); Yuri Sidorow, Kiev (UA)

Correspondence Address: LITMAN LAW OFFICES, LTD., P.O. BOX 15035 CRYSTAL CITY STATION, ARLINGTON, VA, 22215, US

(21) Appl. No.: 10/301,745

(22) Filed: Nov. 22, 2002

(51) Int. Cl. H04B 1/00; H04B 7/00; H04M 1/00; H04B 1/38

(52) U.S. Cl. 455/70; 455/557

(57) ABSTRACT

A master slave cellular communication system includes a master cellular communication device and at least one slave wireless communication device. The master cellular communication device may include a power supply, a micro controller with associated memory, a clock, a transceiving block, an antenna, and an input/output interface coupled to each other via a communication bus and disposed on a circuit board. The slave wireless communication device(s) may be incorporated in any type of powered electronic device, and may include a power supply, a micro controller with associated memory, a clock, a transceiving block, an antenna, and an input/output interface coupled to each other via a communication bus and disposed on a circuit board. The slave wireless communication device(s) may also include one or more modules that may be interconnected to the slave wireless communication device(s) through connectors on a housing of the slave wireless communication device(s).

### BACKGROUND OF THE INVENTION

1. Field of the Invention

The present invention generally relates to communications systems and, more particularly, to an electronic communication system that includes a master wireless device and at least one slave wireless device.

2. Description of the Related Art

Communication devices such as cellular telephones are generally configured as fully independent devices. In some cases a cell phone is combined with a specific built in fixed feature or function, example built in pager or digital camera etc. This invention is unique in that it uses a common cellular phone, with special firmware, as a master to communicate with slaves and slave modules to accomplish virtually any existing electronic feature. For example a master cellular phone may be used to communicate to a slave device, which has been installed in one's car to start car, or unlock door.

The related art is represented by the following references of interest.

U.S. Design Pat. No. 384,937, issued on Oct. 14, 1997 to Yang-chou Liu, shows an ornamental design for a hands-free kit with a charger function for a cellular phone. Liu does not suggest a master slave cellular communication system according to the claimed invention.

U.S. Design Pat. No. 405,457, issued on Feb. 9, 1999 to Shosaku Kawashima, shows an ornamental design for a digital camera with a cellular phone and a portable computer. Kawashima does not suggest a master slave cellular communication system according to the claimed invention.

U.S. Design Pat. No. 418,786, issued on Jan. 11, 2000 to Andrew C. Giamos, shows an ornamental design for a combined steering wheel and cellular phone. Giamos does not suggest a master slave cellular communication system according to the claimed invention.

U.S. Pat. No. 4,661,659, issued on Apr. 28, 1987 to Kosuke Nishimura, describes a wireless phone system. Nishimura does not suggest a master slave cellular communication system according to the claimed invention.

U.S. Pat. No. 5,673,307, issued on Sep. 30, 1997 to Bruce M. Holland et al., describes a handoff method for an indoor cellular phone system. Holland et al. does not suggest a master slave cellular communication system according to the claimed invention.

U.S. Pat. No. 5,974,333, issued on Oct. 26, 1999 to Tonny Chen, describes an automobile acoustic unit that has an integrated cellular phone capability. Chen '333 does not suggest a master slave cellular communication system according to the claimed invention.

U.S. Pat. No. 6,002,945, issued on Dec. 14, 1999 to Dennis McDuffee, describes a combination pager and cellular telephone that has an extensible, flexible mouthpiece. McDuffee does not suggest a master slave cellular communication system according to the claimed invention.

U.S. Pat. No. 6,052,603, issued on Apr. 18, 2000 to Richard M. Kinzalow et al., describes a system for interfacing a communication device with a radio for hands-free operation. Kinzalow et al. does not suggest a master slave cellular communication system according to the claimed invention.

U.S. Pat. No. 6,078,825, issued on Jun. 20, 2000 to Stan S. Hahn et al., describes a modular wireless headset system for hands free talking. Hahn et al. does not suggest a communication cellular system according to the claimed invention.

U.S. Pat. No. 6,115,616, issued on Sep. 5, 2000 to Arnold Halperin et al., describes a hand held telephone set with a seperable keyboard. Halperin et al. does not suggest a master slave cellular communication system according to the claimed invention.

U.S. Pat. No. 6,131,042, issued on Oct. 10, 2000 to Chang Lee et al., describes a combination cellular telephone radio receiver and recorder mechanism for vehicles. Lee et al. does not suggest a master slave cellular communication system according to the claimed invention.

U.S. Pat. No. 6,134,456, issued on Oct. 17, 2000 to Stephen Chen, describes an integrated mobile-phone handsfree kit combined with an existing vehicular stereo system. Chen '456 does not suggest a master slave cellular communication system according to the claimed invention.

U.S. Pat. No. 6,154,663, issued on Nov. 28, 2000 to Takeshi Itamochi, describes a portable telephone communications system. Itamochi does not suggest a master slave cellular communication system according to the claimed invention.

U.S. Pat. No. 6,163,711, issued on Dec. 19, 2000 to Esa Juntunen et al., describes a hands free adapter for interfacing a mobile phone handset with an existing audio system. Juntunen et al. does not suggest a master slave cellular communication system according to the claimed invention.

U.S. Pat. No. 6,173,195 B1, issued on Jan. 9, 2001 to Chi-An Chen, describes a wireless mobile telephone adapter for automobiles. Chen '195 does not suggest a master slave cellular system communication according to the claimed invention.

International Pat. document WO 98/12867, published on Mar. 26, 1998, describes an audio output for a hands-free portable telephone accessory. International '867 does not suggest a master slave cellular communication system according to the claimed invention.

None of the above inventions and patents, taken either singularly or in combination, is seen to describe the instant invention as claimed. Thus a master slave cellular communication system solving the aforementioned problems is desired.

### SUMMARY OF THE INVENTION

The present invention is a master slave cellular communication system that includes a master cellular communication device and at least one slave wireless communication device. The master cellular communication device may be configured in the form of a cellular telephone. The cellular telephone may also include a local position system (LPS) as a main source for determining the location of the master cellular telephone. In addition, the wireless mobile telephone may include a GPS as a secondary source for determining the location of the master wireless mobile telephone, if desired. The new function of the master is to communicate and access features of the slave and slave modules.

The slave wireless communication device(s) may be incorporated in any type of powered electronic device. The slaves purpose is to allow master to remotely thru cell phone access and control any of the electronic features contained or connected to it. The slave wireless communication device(s) may also include one or more modules that may be interconnected to the slave wireless communication device(s) through connectors on a housing of the slave wireless communication device(s).

The slave wireless communication device(s) include means for providing standard telephone functions. Coding and/or decoding of messages may occur through a radio channel to mobile protect against extraneous interruption. The slave wireless communication device(s) includes a housing in which reside all of the slave wireless communication device(s) elements with the exception of the modules, which may be inserted and/or removed from the slave wireless communication device via connectors or plugs. The housing may be dimensioned and configured according to the desires of the user, and may include a universal plug connection.

Each expansion module of the slave wireless communication device(s) adds a function or feature to the slave. Each module may contain signal conditioning for control and response signals, and may require electric circuits to execute a pledged function. Expansion module may also be a firmware addition.

For example, functions of the expansion modules may include garage door opening, wirelessly paying toll fees while passing through a pay toll, defining device coordinates, starting the engine of a motor vehicle, reading out and/transmitting the measurements of different counters and sensors, etc.

Each function provided by a particular module of the slave wireless communication device(s) may obtain and/or utilize data received wirelessly and/or non-wirelessly from elements external to the slave wireless communication device, such as sensors, end users mechanisms or devices, input/output devices and/or displays, interface units from different external units, or the like.

Operation of the modules of the slave wireless communication device(s) are designed to be self-sufficient, executing the desired functions without extraneous intervention. Each module of the slave wireless communication device(s) has sufficient powers for execution of algorithms according to desired functions, receiving and/or transmitting message packages with inquiries and/or answers, and for execution of control conditioning, configuration and/or initializing algorithms for the master cellular communication device.

Service for the master cellular communication device and slave wireless communication device may be provided in a predetermined zone of an appropriate provider providing services of a mobile communication link, or a predetermined zone that periodically gets hit by an appropriate provider.

The master cellular communication device is assigned a predetermined telephone number and the slave wireless communication device(s) are assigned the same predetermined telephone number and a predetermined extension number. The master cellular communication device and the slave wireless communication device(s) communicate with each other by a wireless communication using any known protocol. The master cellular communication device and the slave wireless communication device(s) may all be activated by the predetermined number.

Accordingly, it is a principal aspect of the invention to provide a master slave cellular communication system that includes a master cellular communication device; at least one slave wireless communication device with modules; the slave device is to be incorporated with a powered electronic device.

It is another aspect of the invention to provide a master slave cellular communication system that includes at least one slave wireless communication device with modules; wherein at least one slave wireless communication device is incorporated with a powered electronic device.

It is an aspect of the invention to provide improved elements and arrangements thereof in a master slave cellular communication system for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a block diagram of a master slave cellular communication system according the present invention.

FIG. 2 is a block diagram of a slave wireless communication device according to the present invention.

FIG. 3 is a block diagram of a slave wireless communication device example of a weather map.

FIG. 4 is a block diagram of a slave wireless communication device for automobile application example.

FIG. 5 is a block diagram of a slave wireless communication device for a home utility application example.

FIG. 6 is a block diagram of a slave wireless communication device for a utility company application example.

FIG. 7 is a diagram of a Local Position System (LPS).

Similar reference characters denote corresponding features consistently throughout the attached drawings.

### DETAILED DESCRIPTION OF THE PREFERRED EMBODIMENTS

The present invention is a master slave cellular communication system. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to, the illustrated embodiments.

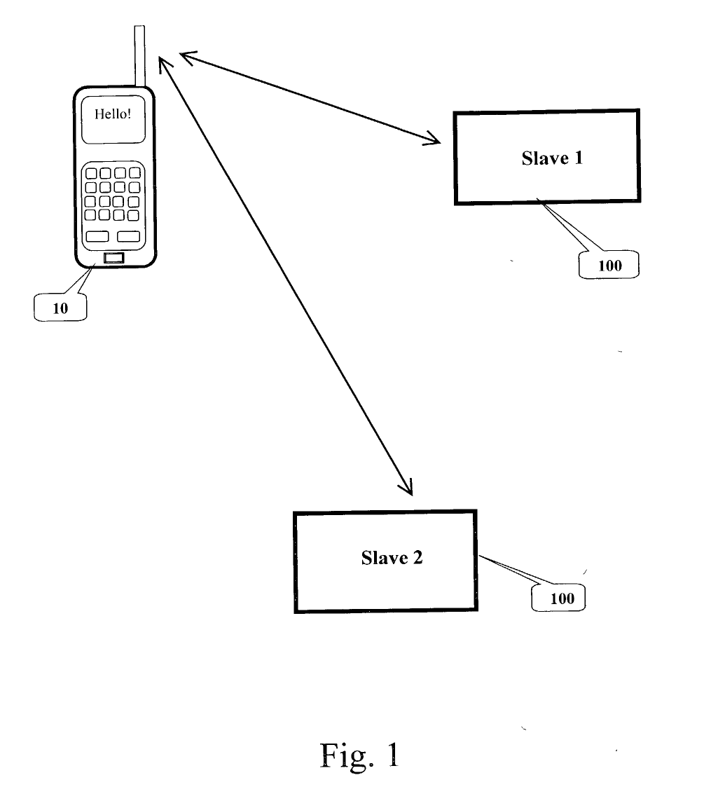

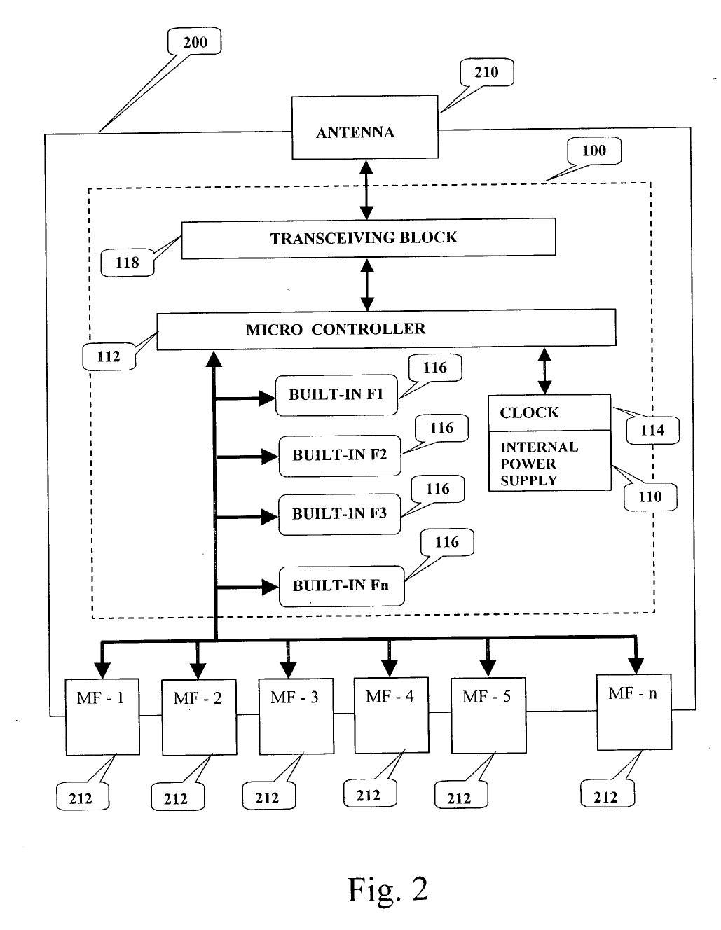

Referring to FIGS. 1 and 2, the master slave cellular communication system includes a master cellular communication device 10 and at least one slave wireless communication device 100. The master cellular communication device 10 is in the form of a standard cellular telephone. Such a cellular mobile telephone may include a power supply, a micro controller with associated memory, a clock, a transceiving block, and an antenna. These elements are used to perform their conventional functions known in the art.

Master cellular communication device 10 may also include a local position system (LPS) as a main source for determining the location of the master cellular mobile telephone. In addition, the master cellular communication device 10 may include a GPS as a secondary source for determining the location of the master wireless mobile telephone, if desired. The LPS is preferable because it is much more inexpensive than the GPS. In addition, the LPS may operate in the same frequency range as the cellular mobile telephone, it is more accurate, and it is more flexible in use.

In addition to its standard cellular phone functions the master device can communicate to its slave device using any know communication protocol. The master cellular communication device will be programmed with special software/firmware allowing it to access and control the features of the slave communication device and its modules from the keypad. The master will also be capable of receiving information from slave, which can be displayed, on the master cell display.

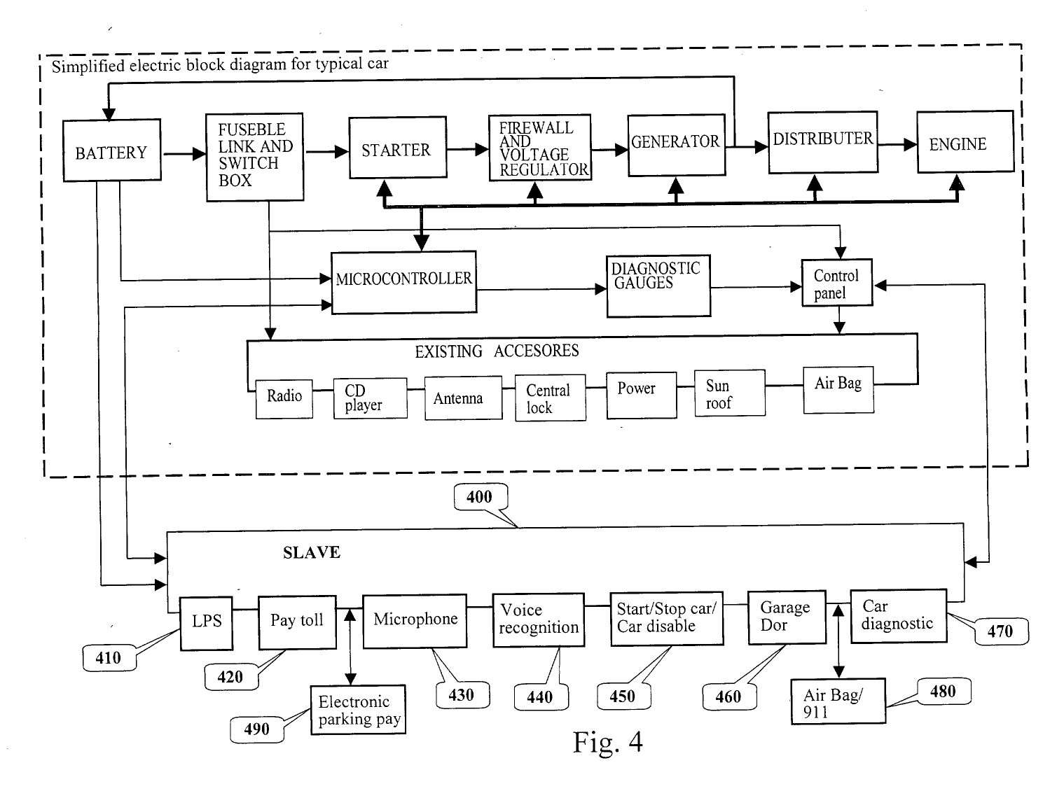

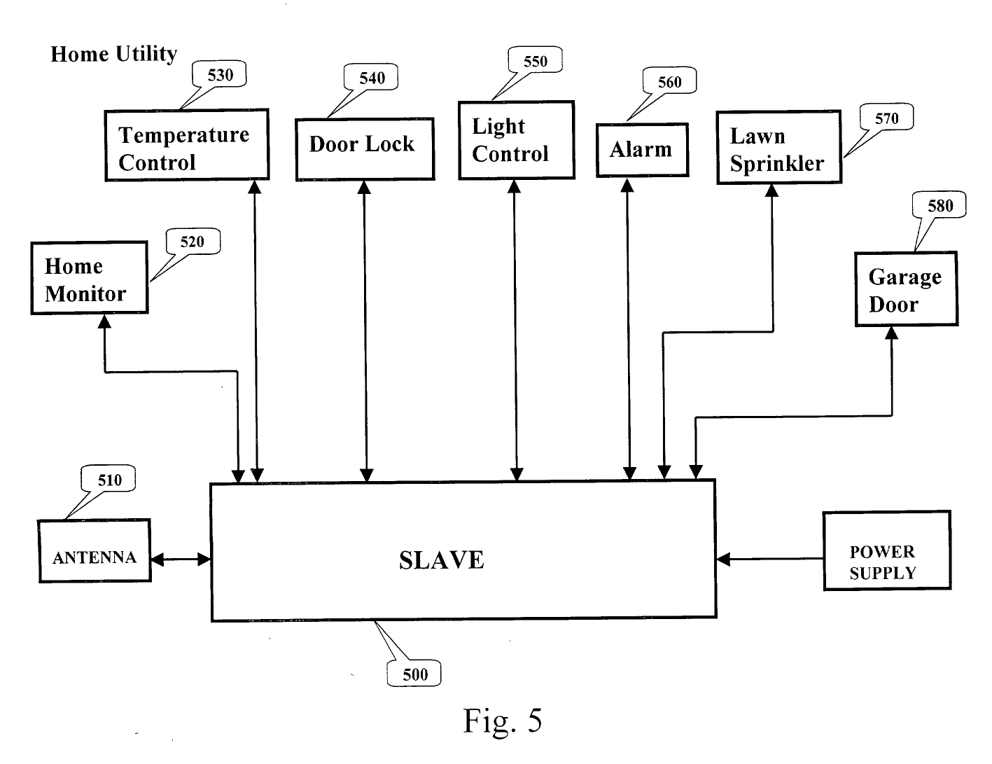

Slave wireless communication device 100 may be incorporated with any type of powered electronic device. For example, slave wireless communication device 100 may be incorporated into a motor vehicle electronic system FIG. 4, home utility system FIG. 5, or the like.

As shown in FIG. 2, slave wireless communication device 100 includes a power supply 110 for internal clock, a micro controller 112 with associated memory, a clock 114, a transceiving block 118, an antenna 210, and an input/output interface for enabling coupling of external modules 212 via connectors or plugs, coupled to each other via a communication service bus and disposed on a circuit board. Slave wireless communication device 100 may also include one or more modules 212 that may be interconnected to slave wireless communication device 100 through connectors on a housing of slave wireless communication device 100.

The micro controller 112 and associated memory of slave wireless communication device 100 include micro controller useable software code means 116 including instruction means for providing standard telephone functions. Coding and/or decoding of messages may occur through a radio channel to protect against extraneous interruption. The communication service bus may be level shiftable for data exchange between a base part and plugable modules. Antenna 210 may be internally included in housing of slave wireless communication device 100, or may be externally included in external modules 212 for slave wireless communication device 100. Real-time clock 114 is synchronized by external signals with a current provided by power supply 110. Slave wireless communication device 100 includes a housing in which resides all of slave wireless communication device 100 elements with the exception of modules 212 which may be inserted and/or removed from slave wireless communication device 100 via connectors or plugs. The housing of slave wireless communication device 100 may be dimensioned and configured according to the desires of the user, and may include a universal plug connection.

The slave wireless communication device 100 may include a micro controller and associated memory, wherein the module micro controller includes micro controller useable software code means including first instruction means for providing data exchange services with the communication service bus, second instruction means for providing reception and signal conditioning for control and response signals, third instruction means for requiring electric circuits to execute a pledged function, fourth instruction means for initializing modules, and fifth instruction means for monitoring and managing power inside the slave wireless communication device.

Each function provided by a particular module 212 of slave wireless communication device 100 may obtain and/or utilize data received wirelessly and/or non-wirelessly from elements external to slave wireless communication device 100, such as sensors, end users mechanisms or devices, input/output devices and/or displays, interface units from different external units, or the like.

Operation of modules 212 of slave wireless communication device 100 is designed to be self-sufficient, executing the desired functions without extraneous intervention. Each module 212 of slave wireless communication device 100 has sufficient powers for execution of algorithms and desired functions. Each module will be capable of receiving and/or transmitting message packages with inquiries and/or answers to and from slave if required. Each module will be capable of self-execution, control conditioning, configuration and/or initializing algorithms for itself on command by the master cellular communication device.

Initialization occurs in the following manner: (a) at power up, the slave wireless communication device already “knows” modules that have previously been installed or connected; (b) on a priority basis, the modules are initialized and interrogated with a prior configuration which has been stored in the memory of the slave wireless communication device, and the communication service bus is checked for any new module units; (c) all modules provide confirmation of their presence in a predetermined period of time, and if confirmation is not provided after the predetermined period of time expires, absence of the corresponding module is noted and/or recorded, and a message is sent out about the absence or malfunctioning module; (d) upon detection of a new module, inquiry is made about the functions of the new module, and a message is transmitted to the master cellular communication device regarding the new module and saved in the memory of the master cellular communication device; (e) an answer package regarding successful initialization of new functions of a new module is generated, and only after arrival of a confirmation does the slave wireless communication device register for itself and the new module a new “legitimized” serial number for the new module in the memory of the slave wireless communication device; (f) the module functions allow the master and slave wireless communication devices to administer the initialization function, and to inquire about the state or course off execution; and (g) reinitialization of the slave wireless communication device may be effected by a command transmitted by the master cellular communication device.

Master cellular communication device 10 and slave wireless communication device 100 lie in a cover zone of an appropriate provider providing services of a mobile communication link, or a predetermined zone that periodically gets hit by an appropriate provider.

Master cellular communication device 10 is assigned a predetermined telephone number and slave wireless communication device(s) 100 are assigned the same predetermined telephone number and a predetermined extension number. Master cellular communication device 10 and slave wireless communication device(s) 100 communicate with each other by wireless communication using any known protocol. The predetermined number may activate all master cellular communication device 10 and the slave wireless communication device(s) 100.

A family including parents and children may use the master slave cellular communication system according to the invention with a parent maintaining the master cellular communication device and the children maintaining the slave wireless communication devices. The parent may then obtain information from the slave wireless communication device(s), such as location information via LPS or the like.

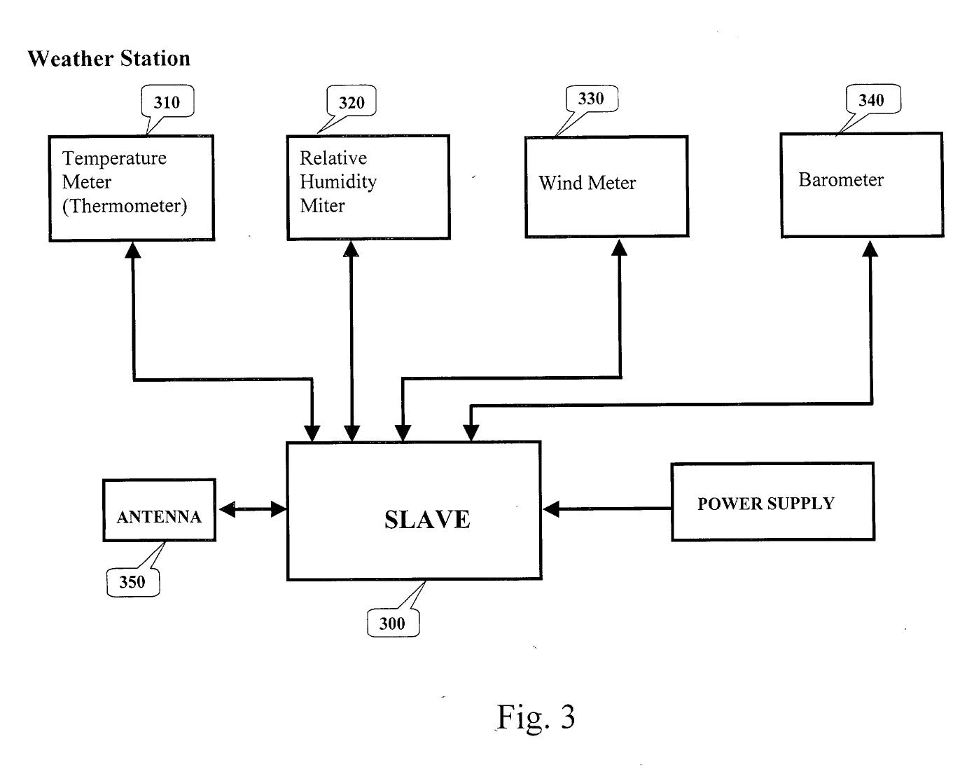

Example of use is illustrated in FIG. 3 (Block diagram of slave weather map). To create a weather map of any state, suppose it is necessary to monitor 500 different locations, to measure temperature 310, humidity 320, wind speed 330, air pressure 340. In this case we would require 500 slaves 300 placed at specified locations in the state. The slaves could be quarried by computer or master for specific weather information from each uniquely identified slaves (by ext number). A map may be easily, quickly, and accurately created with data from slaves.

Another example of use is illustrated in FIG. 4 (Block diagram of slave for automobile). Slave 400 installed in car would allow owner to remotely use any of the modules (features) connected to slave 400. For example, locate car 410 (LO JACK), start/disable car 450. Not only module (features) but also any electronic features built into car may also be accessed for examples lock/unlock doors, open/close windows. Slave may also include airbag/911 module 480 which would call 911 and give police location of vehicle if air bag is deployed in an accident.

Another example of use is illustrated in FIG. 5 (Block diagram of slave Home Utility). Slave 500 Installed in a home would allow homeowner to call slave 500 and access any module (feature) by phone. For example one could turn temperature controller up/down 530, turn lights On/off 550, turn alarm on/off 560, lock/unlock door 540.

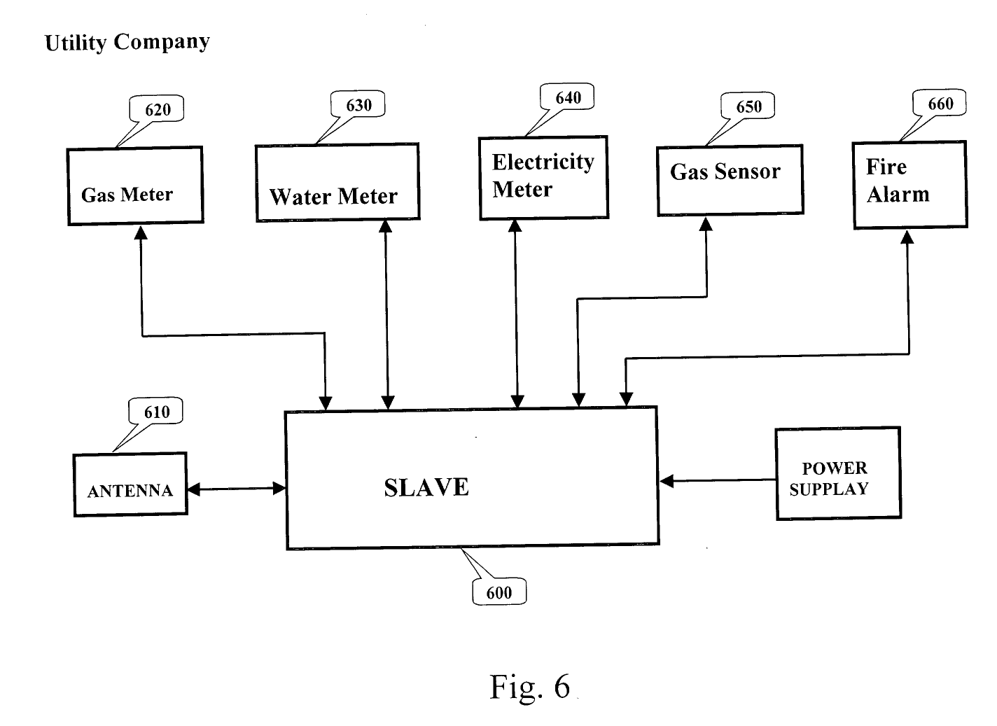

Another example of use is illustrated in FIG. 6 (Block diagram of slave for Utility Company). Utility company could install slaves 600 in homes. Utility company could call a certain number for neighborhood and extension number for certain house and inquire slave 600 about utility usage, gas 620, water 630, electricity 640. Slave 600 could also have sensors for gas 650 and fire 660, upon detection of either would call 911 and give police street address and sensed problem.

Local Positioning System (LPS)

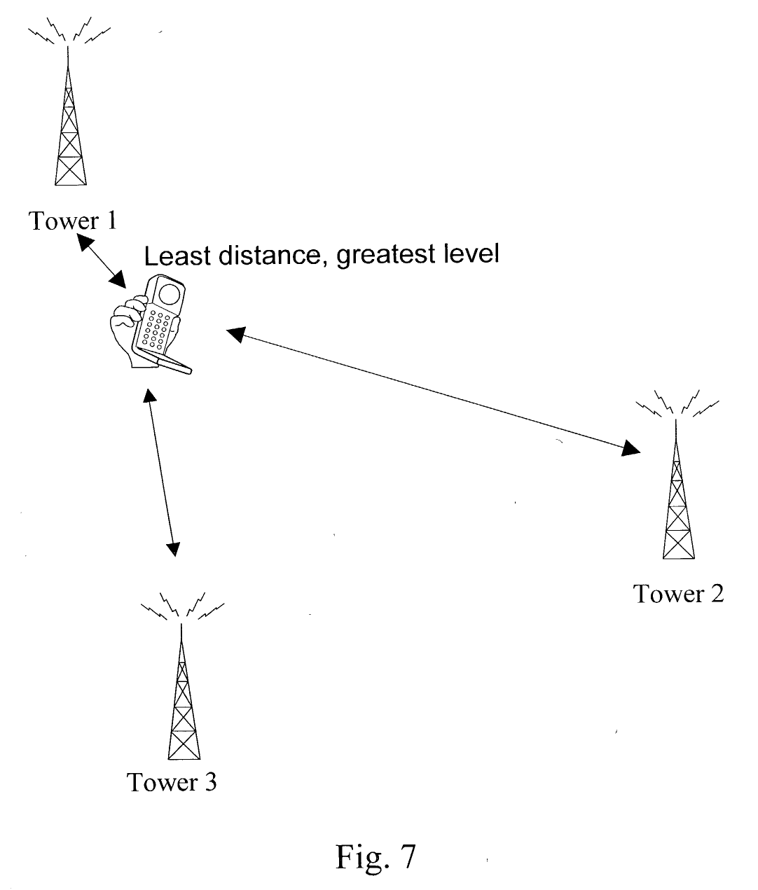

All cellular telephones define a signal level up to at least one cellular tower to perhaps several towers at same time. Using the signal level strength, coupled with tower location and directional sensor received on it is possible to accurately calculate the position coordinates of a requested phone, or slave device. These coordinated can be processed into street locations or landmark using electronic maps (FIG. 7). The master or slave device coupled with special firmware features can allow user to turn on/ off locate feature (like caller ID for telephone).

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

We claim:

1. A master slave cellular communication system comprising:
a master cellular communication device;
at least one slave wireless communication device;
wherein the at least one slave wireless communication device is incorporated with a powered electronic device.

2. The master slave cellular communication system according to claim 1, wherein the master cellular communication device comprises a power supply, a micro controller with associated memory, a clock, and a transceiving block coupled to each other by a communication service bus.

3. The master slave cellular communication system according to claim 2, wherein the master cellular communication device further comprises an antenna and an input/output interface.

4. The master slave cellular communication system according to claim 2, wherein the master cellular communication device further comprises a local position system.

5. The master slave cellular communication system according to claim 1, wherein the micro controller and associated memory includes micro controller useable software code means including first instruction means for providing receiving and dispatching short message system messages.

6. The master slave cellular communication system according to claim 1, wherein the slave wireless communication device comprises a power supply, a micro controller with associated memory, a clock, and a transceiving block coupled to each other by a communication service bus.

7. The master slave cellular communication system according to claim 6, wherein the micro controller and associated memory includes micro controller useable software code means including first instruction means for providing telephone functions.

8. The master slave cellular communication system according to claim 6, further comprising at least one module, including a module micro controller and associated memory useable software code means including first instruction means for first instruction means for providing data exchange services with the communication service bus, second instruction means for providing reception and signal conditioning for control and response signals, third instruction means for requiring electric circuits to execute a pledged function, fourth instruction means for initializing modules, and fifth instruction means for monitoring and managing power inside the slave wireless communication device.

9. The name Local Positioning System and (LPS).

10. Idea of using information already possessed by cellar phone companies (cellular signal strength and tower location) to be computed into position coordinates and return street locations.
